(19) United States
(12) Patent Application Publication
(10) Pub. No.: US 2014/0360881 A1
(43) Pub. Date: Dec. 11, 2014

(54) ELECTRO-MARK PROCESS AND DECORATION OF METALLIC SURFACE AND RELATIVE DEVICE

(71) Applicant: METALY S.R.L., Formigine, MO (US)

(72) Inventors: Stefano Muratori, Formigine (IT); Andrea Pallotti, Sassuolo (IT)

(73) Assignee: METALY S.R.L., Formigine, MO (US)

(21) Appl. No.: 14/245,963

(22) Filed: Apr. 4, 2014

(30) Foreign Application Priority Data
Apr. 5, 2013 (IT) MO2013A000089

(51) Int. Cl. B41M 5/20

(52) U.S. Cl. CPC B41M 5/20
USPC 205/56; 205/52; 204/227

(57) ABSTRACT

A process of chemical electro-marking includes the operation of placing the metal surface to be decorated in a position of application in which there is a silk screen, an electrode with a suitable pad soaked with etching solution, interposed between the electrode and the metal surface to be treated with the decoration, drawing or writing; and includes a phase of preliminary application of the negative shape of the decoration, drawing or writing by means of a chemical product of protection of the metal surface being treated, on the metal surface itself and resistant to the action of electrochemical etching of the marking; the action of decoration by chemical electro-marking is performed by applying the silk screen which has no masking and is resistant to the etching action of the chemical solution used, for the specific metal of the treated surface; the motion of the electrode with said pad, driven to slide on the surface of the silk screen, as known in the art, therefore, does not act mechanically on the masking damaging it, but only due to the electrochemical action of marking in the zone momentarily affected by the electrode and not protected by said masking.

### FIELD OF THE INVENTION

The present invention relates to a process of chemical electro-marking with decoration of metal surfaces, that is to say, an improved way of making the decoration with chemical electro-marking of metal surfaces and that performs the operation of decoration in a rapid, precise and economical way. The device that makes the application of the improved method possible is also included.

### PRIOR ART

The prior art includes the very well-known process of chemical electro-marking of metal surfaces in which with an electrode and an element absorbing the etching solution, interposed between the electrode and the metal surface, one activates the electrochemical action of localised oxidation of the metal concerned and exposed to said action.

In electro-marking one often uses a masking to realize precise shapes of the oxidation, in such a way as to realize the shapes of letters, thus realizing writings, figures, drawings etc. keeping the latter firmly attached to the metal surface.

Furthermore, in the prior art it is also known that the action of electro-marking of metal surfaces, which is possible when the metal surface also conducts a weak electric current—to excite the action of etching to the metal surface some chemical solutions are used—is performed manually, in such a way as to limit the use of this type of writing/decoration to small areas of the metal surface due to the high realization costs. Some etching chemical solutions are available on the market, which can be used for the electro-marking of the various metals, as well as for non-anodized aluminium, but with unsatisfactory marking results if the aim of the working is to obtain large amounts of plates or decorated metal surface, because, as said, the working must be carried out manually.

In the technique for decorating metal surfaces, having a small but also a large surface and in large amounts, the most varied methods of superficial printing have been used. Ink silk-screen printing and tampography processes are known, in which the ink is transferred and released on the metal surface without penetrating it and remaining as a very thin layer of ink on the surface. However, they all realize a decoration which over time and with use is intended to be lost by removal of the inserted ink, even if consolidated, from the metal surface.

As stated above, only the action of electro-marking is resistant over time because it penetrates the metal of the treated surface, even if at a very shallow depth in the order of some tens of nanometres, and it can be removed only by mechanical abrasion, that is to say, removing the metal of the surface.

In fact, the present limit of the state of the art lies in the impossibility to apply an electro-marking treatment of surface decoration of the metal plates and large metal surfaces with productions of large amounts of treated surface, owing to the limitation of the operation performed manually.

Finally, the processes of silk-screen printing decoration or with ink transfer are known, which are typical of the decorations of large surfaces in other fields, such as ceramic tiles, paper etc., which cannot be transferred to this field due to the peculiarity of the operation of chemical electro-marking, where in the restricted space between the electrode and the surface to be decorated a localised electrolytic mini-cell is formed, which modifies the metal of the surface to make it change from the original colour to the typical colour of its oxide.

Therefore, it is known to carry out the chemical electro-marking with small screens on which the figure, decoration, writing that one wishes to obtain is reproduced negatively. The transfer of this technique of using a silk-screen provided with masking and resistant to the etching action of the solution used for the specific metal brings about too high costs if the aim is to decorate large surfaces and at the same time to make flexible the variation of the decoration applied to the sheet, roll metal sheet, wire cloth or metal surface in general also for few or one single application of the above-mentioned figure, decoration or writing.

Moreover, the prior art document WO 2012/107833 is known, in which a process of electrochemical marking of a metal surface of aluminium is described that, at the end of the marking in several phases as well, is treated by surface anodizing in such a way as to incorporate the so obtained drawing or writing in the surface itself. In it the electrochemical marking process is described, in which there is a masking with a screen having a usual negative drawing of the requested decoration or also a masking with the application of a negative drawing of the requested decoration directly on the metal surface of aluminium to be treated; the chemical electro-marking is applied by means of the screen provided with the masking or directly with the pad on the surface protected by the masking that, as said, to must be resistant to the abrasion of the surface of the pad impregnated with the electrochemical marking solution.

The process described in this document, in the making of the masking directly on the surface being treated with a masking product that makes up a temporary surface masking, includes the masking with film or ink, which needs to resist the abrasive action of the pad and that, after the chemical electro-marking treatment, is difficult to be removed being of “film”, that is to say, a layer applied with adhesive, or of solid ink and resistant to the abrasion of the pad, which as said is difficult to be removed because it is consolidated and of suitable tackiness on the metal plate being treated. Therefore, after the treatment, the removal of the masking occurs, if applied to the silk screen, by removing the screen or, if applied to the treated surface, by removing the masking of “film” or ink that, as said, being resistant to the abrasive action, requires a strong action of removal.

This prior art is susceptible of important improvements with reference to the possibility to perform a chemical electro-marking process with the decoration of metal surfaces, which exceed the flexibility limit of the prior art and that realizes the application to the metal surface in general of a decoration, drawing or writing in an economical and fast way in the removal of the masking.

Therefore, the technical problem, which is at the basis of the present invention is to realize a working process that reproduces the action of chemical electro-marking, already known for manual use, and at the same time is applicable to large surfaces, or even small and restricted, but that in the realization of the decoration can be economical, as well as in the realization of limited series or even single decorations.

An aim included in the previous technical problem is to realize a way of masking of the surface to be decorated that is economical in its realization and safe in the protection of the parts of surface that must remain untouched for the application of the decoration, drawing or writing and after the removal of the masking at the end of the electro-marking treatment.

Finally, a further part of the technical problem mentioned above relates to the removal of the masking necessary for making the decoration, drawing or writing, and which is realizable in an easy, economical, complete and non-polluting way.

### SUMMARY OF THE INVENTION

Said technical problem is solved, according to the present invention, by a chemical electro-marking process comprising the operation of placing the metal surface to be decorated in a position of application in which there is a silk screen, an electrode with an appropriate pad soaked with the etching solution, interposed between the electrode and the metal surface to be treated with the decoration, drawing or writing; characterised in that it includes a phase of preliminary application of the negative form of the decoration, drawing or writing by means of a chemical product of protection of the metal surface being treated, on the metal surface itself and resistant to the action of electrochemical etching of the marking; the action of decoration by chemical electro-marking is performed by applying the silk screen which has no masking and is resistant to the etching action of the chemical solution used for the specific metal of the treated surface; the motion of the electrode with said pad, driven to slide on the surface of the silk screen, as known in the art, therefore, does not act mechanically on the masking damaging it, but only due to the action of electrochemical marking in the zone momentarily affected by the electrode and not protected by said masking; after completing the marking of the metal surface, the screen is removed and the metal surface is cleaned of the masking by suitable washing for removing said masking.

In a specific form of the method of treatment by chemical electro-marking the masking is applied by means of a process of printing for large surfaces such as flexography.

In a further form of treatment by chemical electro-marking the masking is applied by means of a serial printing process such as tampography.

In a specific form of treatment by chemical electro-marking the masking is applied by means of a versatile and composite printing process at every action of marking, as using an ink-jet printer.

In a preferred form of treatment by chemical electro-marking the masking is made with an alcohol-based ink, so as to evaporate the solvent in a short time after the application on the metal surface to be treated.

In a further form of treatment by chemical electro-marking the masking is made with an industrial solvent ink laid by the ink jet on the metal surface pre-heated before printing.

Moreover, in a variant of the treatment the masking is made with ink comprising ethyl cellosolve and propylene glycol methylether in solution.

Furthermore, preferably the masking, made with alcohol-based ink, after the chemical electro-marking treatment is removed with denatured alcohol solvent.

In a variant of application of the electro-marking treatment the masking is applied with a painting-like manual process, that is to say, the masking is extemporaneous and different in every following action of marking.

Device for the application of an electro-marking method comprising a masking with a low-cohesion masking product, characterised in that it comprises a passage silk screen, that is to say, with no masking on the screen itself.

In a variant of said device the passage silk screen includes nylon threads with a density of 120 threads/square cm.

In a preferred embodiment of the device the low-cohesion masking product includes alcohol-based industrial solvent ink.

Moreover, in a further preferred embodiment said device employs the low-cohesion masking product, which comprises alcohol-based ink containing propylene glycol methylether and ethyl cellosolve.

In a specific embodiment the passage silk screen is arranged planarly being supported by a rigid frame.

Finally, in another embodiment the passage screen is arranged wound on the cylindrical surface of a drum, kept tensioned between two rim rings on the base circumferences of said drum shape.

The features and the advantages of the present invention, in the realization of a chemical electro-marking process, will be clear from the description, made in the following, of an embodiment of the decoration by electro-marking on a metal surface given as an indicative and not limitative example with reference to the drawing table enclosed.

### SHORT DESCRIPTION OF THE DRAWINGS

FIG. 1 shows a schematic perspective view of a generic operation of chemical electro-marking according to the invention in which a metal plate being decorated, a generic chemical electro-marking electrode and a passage screen, that is to say, with no masking, are shown as well as the masking applied directly to the underlying metal surface being treated;

FIG. 2 shows a schematic perspective view of a generic machine for the electro-marking of large metal surfaces in which an electrode is provided with devices for the movement of the pad and is supported in a mobile way on the passage screen of protection from the mechanical action of the masking present on the metal surface being treated: the spaced representation between the screen and the surface shows the underlying metal surface being treated with the masking.

### DETAILED DESCRIPTION OF A PREFERRED EMBODIMENT

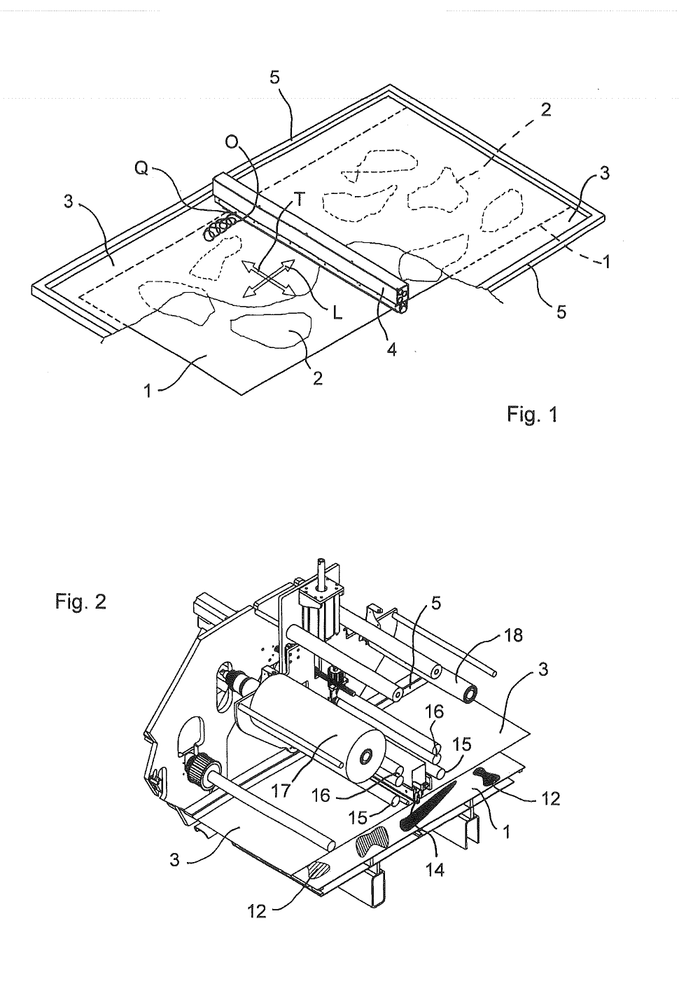

To the metal surface 1 being treated, as visible in FIG. 1, one applies a masking 2 by means of a device suitable to distribute the masking on the surface 1, such as ink jet printing, tampography and similar printing processes. Afterwards, the metal surface being treated is placed in the working position where it is covered by a passage silk screen 3, that is to say, with no masking, and then an electrode 4 of activation of the electro-marking treatment is drawn near. The electrode 4 is driven to cover the whole metal surface 1 by means of movements in the longitudinal L and transverse T direction, which are combined to realize an orbital motion O of a same point Q of the electrode 4 on the surface of the screen. The screen is provided with a usual tensioning frame 5.

The masking of the metal surface 1 is made by means of ink or chemical product impression in an even thin layer, but resistant to the etching solution to carry out the chemical electro-marking, which will be used for the specific metal of the surface 1, also using an ink-jet printer, obviously suitable for the use of the specific ink necessary in the ink masking, or by any means suitable for printing such as tampography, flexography and the like.

The passage screen, that is to say with no masking and therefore with no shape that may prevent the correct passage of the electrolytic action of marking between an electrode, placed in the upper part of the screen, and the metal surface being treated, placed under the screen, is made with a usual silk-screen printing mesh, also of plastic material such as nylon or polyester.

The chemical electro-marking takes place, as said, with the sliding of the electrode on the passage silk screen 3 that, physically detaching the electrode 4 from the masking 2, does not allow the masking itself to be damaged by the continuous passages of the electrode in the various points of the drawing. That is to say, the ink used for the masking must be protective, for the chemical etching solution used, but is likely to have low cohesion, to remove the masking 2 in a phase following the electro-marking in a rapid and complete way by washing.

FIG. 2 shows an arrangement similar to the arrangement of FIG. 1, where the metal surface 1 and the passage screen 3 with the frame 5 are placed in a more complex electrochemical decoration machine suitable to treat large surfaces in an industrial way, where an electrode 14 is made mobile to slide on the passage screen in the two longitudinal and transverse directions to realize said combined way. The electrode is associated with some members of support 15, tensioning 16, unwinding 17 and rewinding 18 of a belt pad, absorbing the etching solution, to activate the electro-marking action between the electrode 14 and the underlying surface of the screen 3, which is put into contact with the metal surface 1 to be treated. Therefore, the masking 12 acts as a shield to the electrolytic action, creating the desired non-treated zone. Therefore, the resulting effect of the so realized chemical electro-marking generates the original and desired drawing, steadily fixed to the surface as it is inside the metal superficial layer of the treated surface 1.

The application of the described chemical electro-marking treatment method can be made on flat rigid surfaces such as metal or even flexible plates and tiles, when placed, at least in the restricted zone of action of the electrode, on a backing surface suitable to support the mechanical actions, soft but not null, between the electrode and the metal surface being treated. Moreover, the described method can also be applied to metal mesh, wire cloth or fabric surfaces.

The described process is applied by the specific way of applying the masking with a chemical masking product similar, in its physical consistency, to an ink. Therefore, as described, the masking can be applied by known methods of printing with inks and of high production such as tampography or flexography. Moreover, considering the laying flexibility of the masking with low-cohesion ink, the masking can be distributed on the surface to be treated with an ink-jet printer, so as to be able to vary the printed graphic shape, making it even different between a previous and the following one, thus realizing the desired complete flexibility of the electro-marking method.

Decoration tests were done on a stainless steel plate with an ink-jet printer using solvent ink of the industrial type. The drawing made was instantaneously dried in printing, preheating the surface of the plate being treated directly by the printer, to allow the drying of the ink at contact with the latter.

Therefore, using the heating of the plate before printing, the plate, just come out of the printer as well as after an indefinite time, can be subjected to the electro-marking treatment with the protection of the passage screen (3), interposed between the electrode and the plate decorated with the negative drawing of the drawing or writing that one wants to realize on the metal surface being treated. A further advantage is obtained by using a silk screen of nylon that has 120 threads/square cm, as said with no masking, but only used to be interposed between the chemical electro-marking pad and the masking made with a low-cohesion masking product, namely said industrial solvent ink.

So, in the tests done, it was assessed that the screen protects the negative drawing from the mechanical abrasion and thermal or electrochemical wear performed by the electrode and pad during the chemical electro-marking process. That is to say, when the chemical electro-marking has been completed, the removal of the solvent ink is carried out in an easy and immediate way through a cleaning made with a pad soaked with simple denatured alcohol.

In the experiment carried out the presence of the passage silk screen (3), with no masking, was essential to perform the action of chemical electro-marking on the treated surface. Without the screen with no masking, the masking with the industrial solvent ink was assessed to not resist the passage in contact of the pad soaked with solution activating the chemical electro-marking process. The realization of the masking, with the heating of the plate prior to the passage in the ink-jet printer, further consolidates the applied negative drawing, but, however, does not guarantee that the used alcohol-based industrial solvent ink can resist the abrasion given by the chemical electro-marking pad soaked with solution activating the process.

Good results were obtained using an alcohol-based industrial solvent ink from the firm Durafos Inc. (Republic of Korea) containing ethyl cellosolve in ethyl alcohol and propylene glycol methylether, that is to say, propylene glycol dimethyl ether, under the product name of DESB-SD5xx. The application of this ink proved to be resistant to the electro-marking action with the interposition of the screen with no masking and the previous heating of the plate, although it realizes the immediate possibility of the marking treatment, it does not limit the removability of the ink of the masking with a pad soaked with simple denatured alcohol.

The advantages of a chemical electro-marking process with the decoration of metal surfaces, according to the invention, can be summarized as follows. The electro-marking method with the maximum versatility possible can also be applied to large metal surfaces, be they rigid or flexible.

The decoration, the drawing or writing made on large plates, floor tiles, wire cloth or roll metal sheet, is precise in the definition of the decoration, rapid to be made and very economical, considering the impediment of the electro-marking where the surface is protected by the masking as described above. That is to say, the phase of decoration, with masking product, having the consistency of an ink, allows for versatility in its laying in a simple, rapid way and at the most also with one single or numerically limited decoration; therefore, the mechanical protection of the masking, which is performed by the passage screen, from the necessary sliding action applied by the marking electrode, allows, after the electro-marking, for the removal in a simple, easy and rapid way of the masking, that is to say, of said low-cohesion ink used in the masking.

Obviously, a skilled person of this matter may make several changes to the chemical electro-marking process with decoration of metal surfaces and related device, described above, in order to meet specific and contingent requirements, such changes being all included within the scope of protection of the present invention which is defined by the following claims. Therefore, although less conveniently, the use of aqueous-based inks for the masking can be made with a longer drying time of the ink jet printing on the metal surface of the plate being treated. Furthermore, the passage silk screen (3), that is to say, with no masking, can be made with features different from those of the tests made, that is to say, with a larger or smaller number of threads and also with a material of the threads other than nylon, such as polyester, or another plastic material though always suitable to resist the chemical and thermal stresses of the action of chemical electro-marking on the specific metal surface being treated.

1. A process of chemical electro-marking, comprising:
placing a metal surface to be decorated in a position of application in which there is a silk screen, an electrode with a suitable pad soaked with an etching solution, interposed between the electrode and the metal surface to be treated with a decoration, drawing or writing;
preliminary application of a negative shape of the decoration, drawing or writing by a chemical product of protection of the metal surface being treated, on the metal surface itself and resistant to an action of electrochemical etching of the marking;
decoration by chemical electro-marking which is performed by applying the silk screen which has no masking and is resistant to the etching action of the chemical solution used, for the specific metal of the treated surface, such that a motion of the electrode with said pad, driven to slide on the surface of the silk screen, does not act mechanically on the masking, but only due to an electrochemical action of marking in a zone momentarily affected by the electrode and not protected by said masking; and
after completing the marking of the metal surface, removing the screen and cleaning the metal surface of the masking by suitable washing for removing said masking.

2. The process of chemical electro-marking, according to claim 1, wherein the masking is applied by a printing process for large surfaces.

3. The process of chemical electro-marking, according to claim 1, wherein the masking is applied by a serial printing process.

4. The process of chemical electro-marking, according to claim 1, wherein the masking is applied by a versatile and composite printing process at every action of marking.

5. The process of chemical electro-marking, according to claim 4, wherein the masking is made with an alcohol-based ink, so as to evaporate the solvent in a short time after the application on the metal surface to be treated.

6. The process of chemical electro-marking, according to claim 4, wherein the masking is made with an industrial solvent ink laid by the ink jet on the metal surface pre-heated before printing.

7. The process of chemical electro-marking, according to claim 5, wherein the masking is made with ink comprising ethyl cellosolve and propylene glycol methylether in solution.

8. The process of chemical electro-marking, according to claim 5, wherein the masking made with alcohol-based ink, after the treatment of chemical electro-marking, is removed with denatured alcohol solvent.

9. The process of chemical electro-marking, according to claim 1, wherein the masking is applied by a painting-like manual process, such that the masking is extemporary and different at each following action of marking.

10. A device for the application of a process of electro-marking, comprising:
a masking with a low-cohesion masking product, the masking including a passage silk screen with no masking on the screen itself.

11. The device, according to claim 10, wherein the passage silk screen comprises nylon threads with a density of 120 threads/square cm.

12. The device, according to claim 10, wherein the low-cohesion masking product comprises alcohol-based industrial solvent ink.

13. The device, according to claim 12, wherein the low-cohesion masking product comprises alcohol-based ink containing propylene glycol methylether and ethyl cellosolve.

14. The device, according to claim 10, wherein the passage silk screen is placed planarly being supported by a rigid frame.

15. The device, according to claim 10, wherein the passage screen is arranged wound on the cylindrical surface of a drum, kept tensioned between two rim rings on the base circumferences of said drum shape.
